(19) United States
(12) Patent Application Publication
(10) Pub. No.: US 2021/0383383 A1
(43) Pub. Date: Dec. 9, 2021

(54) DYNAMIC CONFIGURATION OF TRANSFER PERMISSIONS

(71) Applicant: The Toronto-Dominion Bank, Toronto (CA)

(72) Inventors: Michael PRONSKI, Toronto (CA); Clement MA, Oakville (CA); Raphael ROSTENNE, Thornhill (CA)

(73) Assignee: The Toronto-Dominion Bank, Toronto (CA)

(21) Appl. No.: 16/895,090

(22) Filed: Jun. 8, 2020

(51) Int. Cl. G06Q 20/40; G06F 16/23; G06Q 20/34

(52) U.S. Cl. CPC G06Q 20/405; G06Q 20/342; G06F 16/2365

(57) ABSTRACT

A method may include: receiving a trusted list containing electronic contact credentials for a plurality of members of a group; sending one or more electronic messages to one or more members of the group using the electronic contact credentials for each such member of the group; receiving an account provisioning request, the account provisioning request associated with an electronic messaging address; authenticating the account provisioning request as being associated with a member of the group by determining that the electronic messaging address corresponds to one of the electronic contact credentials in the trusted list; and configuring a threshold for an account associated with the account provisioning request to allow a first threshold, the first threshold being a higher threshold than a second threshold which is in effect for an account that is not associated with one of the members of the group.

### FIELD

This relates to the processing of transfers between database records, and, more particularly, to the configuration of transfer permissions for such transfers.

### BACKGROUND

Transfers between database records are sometimes made in accordance with one or more pre-defined permissions. Such permissions may be useful in order to, for example, limit the usage of computing resources or to minimize the effect of unauthorized users performing unauthorized transfers. However, imposing such limits and permissions may also make it difficult for some users who may be prevented from performing a transfer that would otherwise be permitted.

### BRIEF DESCRIPTION OF THE DRAWINGS

Embodiments are described in detail below, with reference to the following drawings:

FIG. 1 is a schematic operation diagram illustrating an operating environment of an example embodiment according to the subject matter of the present application;

FIG. 2 shows the front side of a computer system;

FIG. 3 shows a high-level schematic diagram of a computer system 2;

FIG. 4 shows a simplified organization of software components stored in a memory of the computer system of FIG. 3;

FIG. 5 is a flowchart showing operations performed in remotely provisioning a user account;

FIG. 6 is a flowchart showing operations performed in remotely provisioning a user account;

FIG. 7 is a flowchart showing operations performed in remotely provisioning a user account;

FIG. 8 is an example group management user interface;

FIG. 9 is an example group management user interface;

FIG. 10 is an example message that may be sent to a member of a group based on a trusted list;

FIG. 11 is an example prompt that may be displayed during provisioning of a user account to a server computer system; and

FIG. 12 is a flowchart showing operations performed in loading a virtual gift card.

Like reference numerals are used in the drawings to denote like elements and features.

### DETAILED DESCRIPTION OF EXAMPLE EMBODIMENTS

According to the subject matter of the present application there may be provided a computer system. The computer system may include a processor, a communications module, and/or a memory. The communications module and/or the memory may be coupled to the processor. The memory may store instructions that, when executed by the processor, cause the computer system to: receive, using the communications module via a network, a communication from an administrator device, the communication defining a trusted list containing electronic contact credentials for a plurality of members of a group; send one or more electronic messages, using the communications module via the network, to one or more electronic devices associated with members of the group using the electronic contact credentials for each such member of the group; after sending the electronic messages, receive an account provisioning request, the account provisioning request associated with an electronic messaging address; authenticate the account provisioning request as being associated with a member of the group by determining that the electronic messaging address corresponds to one of the electronic contact credentials in the trusted list; and in response to authenticating the account provisioning request as being associated with a member of the group, configure a threshold for an account associated with the account provisioning request to allow a first threshold, the first threshold being a higher threshold than a second threshold which is in effect for an account that is not associated with one of the members of the group.

Conveniently, in this way, permissions, such as thresholds that affect transfers, may be automatically applied to an account during account provisioning. Notably, such thresholds are dynamically applied such that the thresholds may be different for different users/accounts. The thresholds may be based on the account provisioning process performed by the computer system. For example, an account provisioning process that is more secure may allow a greater threshold to be used.

At least some techniques described herein allow a computer system to authenticate a new user associated with an account. Conveniently, such authentication may be performed remotely by simply exchanging messages between computing devices. This may allow for rapid configuration of new accounts.

In some implementations, instructions may further cause a computer system to, in response to authenticating the account provisioning request as being associated with a member of the group, configure the account associated with the account provisioning request such that transactions made with the account affect a ledger tracking total transactions made by all members of the group.

In some implementations, the threshold may define a maximum transaction value over a defined time period.

In some implementations, the defined time period may be one or more of a day, a week or a month.

In some implementations, the threshold may define a maximum transaction value for a single transaction.

In some implementations, the threshold may define a maximum amount of electronic gift cards that may be purchased by the account associated with the account provisioning request.

In some implementations, the instructions may further cause the computer system to: receive a second account provisioning request, the second account provisioning request associated with a second electronic messaging address; determine that the second account provisioning request is not associated with a member of the group by determining that the second electronic messaging address does not correspond to one of the electronic contact credentials in the trusted list; and in response to determining that the second account provisioning request is not associated with the member of the group, configure an account associated with the second account provisioning request with the second threshold.

In some implementations, the instructions may further cause the computer system to: generate one or more codes in association with the trusted list. The one or more electronic messages may each include at least one of the codes. The account provisioning request may include an indicator. Authenticating the account provisioning request as being associated with a member of the group may include determining that the indicator corresponds to one of the one or more codes.

In some implementations, the indicator may represent user input.

In some implementations, generating one or more codes may include generating a single group code for the group.

According to the subject matter of the present application, there may be provided a computer-implemented method. The method may include: receiving, via a network, a communication from an administrator device, the communication defining a trusted list containing electronic contact credentials for a plurality of members of a group; sending one or more electronic messages via the network to one or more electronic devices associated with members of the group using the electronic contact credentials for each such member of the group; after sending the electronic messages, receiving an account provisioning request, the account provisioning request associated with an electronic messaging address; authenticating the account provisioning request as being associated with a member of the group by determining that the electronic messaging address corresponds to one of the electronic contact credentials in the trusted list; and in response to authenticating the account provisioning request as being associated with a member of the group, configuring a threshold for an account associated with the account provisioning request to allow a first threshold, the first threshold being a higher threshold than a second threshold which is in effect for an account that is not associated with one of the members of the group.

In some implementations, the method may further include, in response to authenticating the account provisioning request as being associated with a member of the group, configuring the account associated with the account provisioning request such that transactions made with the account affect a ledger tracking total transactions made by all members of the group.

In some implementations, the threshold may define a maximum transaction value over a defined time period.

In some implementations, the defined time period may be one or more of a day, a week or a month.

In some implementations, the threshold may define a maximum transaction value for a single transaction.

In some implementations, the threshold may define a maximum amount of electronic gift cards that may be purchased by the account associated with the account provisioning request.

In some implementations, the method may further include: receiving a second account provisioning request, the second account provisioning request associated with a second electronic messaging address; determining that the second account provisioning request is not associated with a member of the group by determining that the second electronic messaging address does not correspond to one of the electronic contact credentials in the trusted list; and in response to determining that the second account provisioning request is not associated with the member of the group, configuring an account associated with the second account provisioning request with the second threshold.

In some implementations, the method may further include: generating one or more codes in association with the trusted list and wherein the one or more electronic messages each include at least one of the codes, and wherein the account provisioning request includes an indicator and wherein authenticating the account provisioning request as being associated with a member of the group includes determining that the indicator corresponds to one of the one or more codes.

In some implementations, the indicator may represent user input.

In some implementations, generating one or more codes may include generating a single group code for the group.

In some implementations, there may be provided a computer-readable storage medium. The computer-readable storage medium may be a non-transitory computer-readable storage medium. The computer-readable storage medium may store instructions which, when executed by a processor of a computer system, cause the computer system to perform a method described herein.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

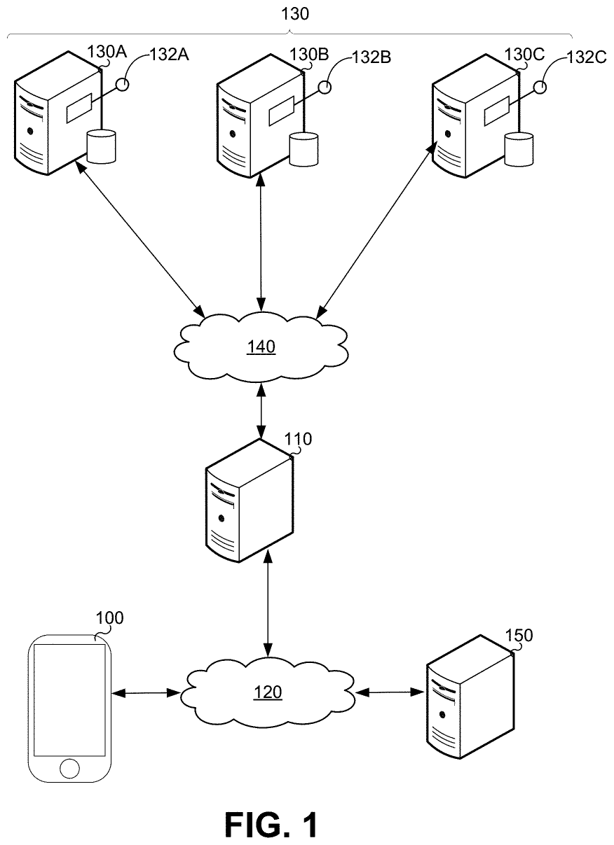

FIG. 1 is a schematic operation diagram illustrating an operating environment of an example embodiment.

As illustrated, a client computer system 100 is in communication with a server computer system 110 via a first network 120. The client computer system 100 is geographically remote from the server computer system 110 and vice-versa.

The server computer system 110 is also in communication with an administrator device 150. Such communication may be by way of a network such as the first network 120. The administrator device 150 is geographically remote from the server computer system 110 and vice-versa.

The server computer system 110 is also in communication with a set of gift card merchant computer server systems 130 via a second network 140. For example, as illustrated, the server computer system 110 may be in communication with a first gift card merchant computer server system 130A, a second gift card merchant computer server system 130B, and a third gift card merchant computer server system 130C, all via the second network 140.

The client computer system 100 may be a mobile computing device such as, for example, a smart phone as shown in the FIG. 1. However, the client computer system 100 may be a computing device of another type such as, for example, a personal computer, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The administrator device 150 is a computer system such as, for example, a desktop or laptop computer, a tablet, a smartphone, or a computer system of another type. The administrator device 150 is associated with and may be operated by an administrator. The administrator may be, for example, an entity that manages a group. The administrator device 150 may be a computer system for managing the group. The group may be, for example, a fundraising group. By way of example, the group may be a sports team and the administrator may be responsible for coordinating fundraising for the sports team (e.g., a coach). In another example, the group may be a school and the administrator may be responsible for coordinating fundraising for the school (e.g., a principal, secretary, etc.). Other examples of groups may include charities and other organizations that typically perform fundraising. In other instances, the group may not be a fundraising group. For example, the group may be a group of employees, a group of members of a club, a union, etc.

The server computer system 110 and each member of the set of gift card merchant computer server systems 130 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, compute servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The first network 120 and the second network 140 are computer networks. In some embodiments, one or both of the first network 120 and the second network 140 may be an internetwork such as may be formed of one or more interconnected computer networks. For example, such a network may be or may include an Ethernet network, an asynchronous transfer mode (ATM) network, a wireless network, or the like. In some embodiments, the first network 120 and the second network 140 may be the same network. For example, the first network 120 and the second network 140 could both be the Internet.

As further described below, the client computer system 100 may be configured with software to allow it to act as a mobile wallet. For example, the client computer system 100 may be configured with a mobile wallet application that allows it to be used for making purchases such as, for example, by displaying a machine-readable indicium (e.g., a bar code) associated with a payment method and/or by performing transactions using near-field communication (NFC). In a particular example, the mobile wallet application may store one or more virtual gift cards that store value, each of which may be used to make purchases from one or more merchants that are associated therewith and/or that accept virtual gift cards of a given type.

The server computer system 110 allows the purchase and/or the reloading of virtual gift cards in real-time and/or near real-time. Clients may communicate with the server computer system 110 to cause virtual gift cards to be purchased and/or reloaded, with those purchased cards and or the reloaded value (as the case may be) then becoming available for immediate or nearly-immediate use. For example, the client computer system 100 may co-operate with the server computer system 110 via the first network 120 to effect a purchase of a virtual gift card such as, for example, to purchase a new virtual gift to be added to its mobile wallet application and/or to reload an existing virtual gift card such as, for example, one already provisioned in the mobile wallet application.

In allowing purchases and/or reloading of virtual gift cards, the server computer system 110 may be configured to implement permissions such as thresholds. Such permissions/thresholds may limit an amount of purchases that may be made. For example, certain thresholds may limit an amount of value of gift cards that may be purchased in any one transaction or over a defined time period (e.g., a day, a week, a month). By way of example, certain accounts may be able to purchase $100 worth of gift cards and others only $50. As will be described in greater detail below, the permissions/thresholds may be configured during onboarding of a new user to the system. For example, during account initialization/provisioning, the permissions/thresholds may be dynamically configured. As will be further described below, the thresholds may be different for different users. For example, the thresholds may depend on an authentication process that has been performed during account provisioning. By way of example, a user that is onboarded through a group authentication protocol may be associated with a higher threshold than a user that has not been onboarded through the group authentication protocol.

Notably, the thresholds may effectively control the use of computing resources at the server computer system 110. For example, a lower threshold may limit the amount of computing resources since the server computer system 110 may be engaged more infrequently when a lower threshold is imposed. Granting users that are associated with a group a higher threshold or better permissions may allow such users to have greater use of computing resources associated with the server computer system 110 since they may be able to engage the server computer system 110 more frequently in order to make more frequent purchases. However, since at least a portion of the account provisioning process has been effectively offloaded to an administrator device, the use of computing resources associated with the server computer system 110 by group members may be similar (or less than) the use of computing resources by non-group members.

The server computer system 110 co-operates with the set of gift card merchant computer server systems 130 via the second network 140 to effect purchases/reloads of virtual gift cards. More particularly, the server computer system 110 may receive communications identifying virtual gift cards to be acquired/reloaded and may then identify a relevant member of the set of gift card merchant computer server systems 130 (e.g., one of the first gift card merchant computer server system 130A, the second gift card merchant computer server system 130B, or the third gift card merchant computer server system 130C) in order to effect purchase of those virtual gift cards. Yet more particularly, to effect such purchases, the server computer system 110 may invoke one or more functions exposed by application programming interfaces (APIs) provided by a given member of the set of gift card merchant computer server systems 130. For example, as illustrated, each of the first gift card merchant computer server system 130A, the second gift card merchant computer server system 130B, and the third gift card merchant computer server system 130C provides a respective gift card application programming interface (API), namely a first gift card merchant API 132A, a second gift card merchant API 1328, and a third gift card merchant API 132C.

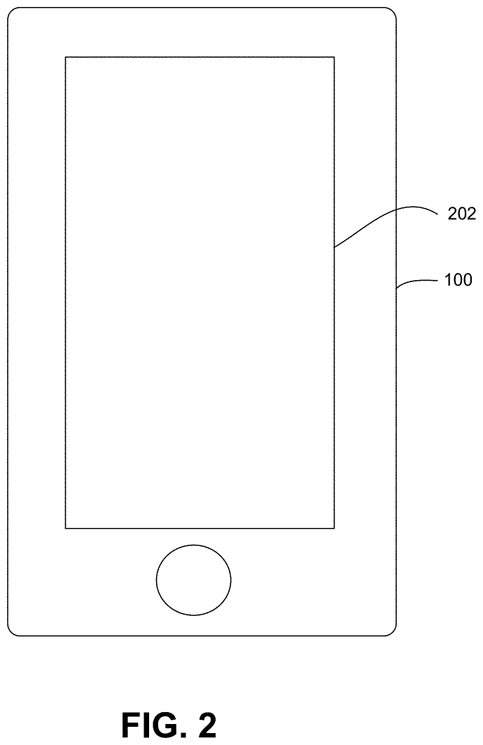

An example embodiment of the client computer system 100 will now be discussed with reference to FIG. 2. The client computer system 100 may, in some embodiments, be a smartphone as shown in FIG. 2. In other embodiments, the client computer system 100 may be another form of computer system. For example, the client computer system 100 may be another form of mobile computing device such as, for example, a tablet.

Referring now to FIG. 2, the front of the client computer system 100 includes a display 202. The display 202 is a module of the client computer system 100. The display 202 is for presenting graphics. The display 202 may be, for example, a liquid crystal display (LCD). In addition to being an output device, the display 202 may also be an input device. For example, the display 202 may allow touch input to be provided to the client computer system 100. In other words, the display 202 may be a touch sensitive display module. In a particular example, the display 202 may be a capacitive touch screen.

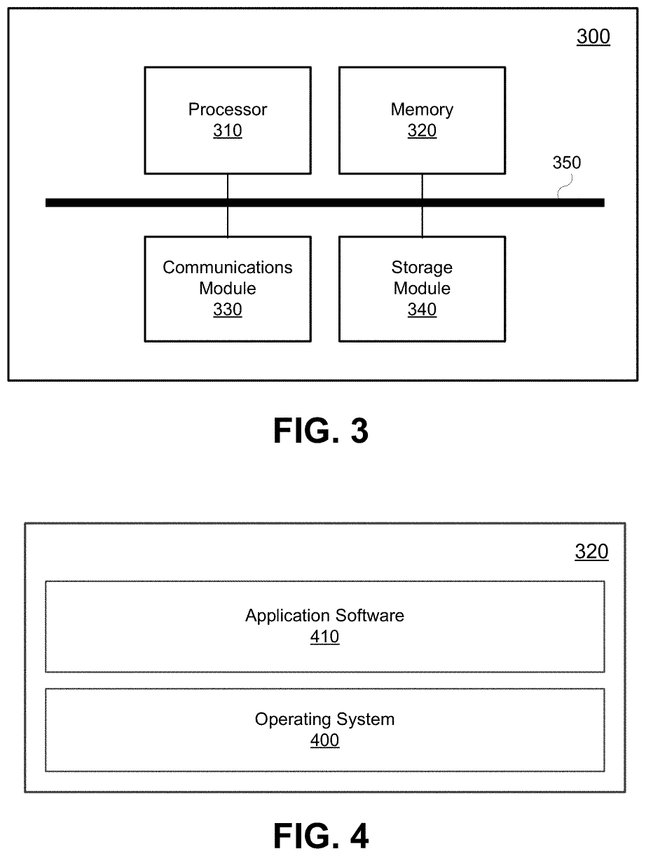

FIG. 3 is a high-level schematic diagram of a computer system 300. The computer system 300 may be any one of the administrator device, client computer system 100, server computer system 110 and/or gift card merchant computer server systems 130.

The computer system 300 includes a variety of modules. For example, as illustrated, the computer system 300 may include a processor 310, a memory 320, a communications module 330, an I/O module 340, and/or a storage module 350. As illustrated, the foregoing example modules of the computer system 300 are in communication over a bus 370. As such, the bus 370 may be considered to couple the various modules of the computer system 300 to each other, including, for example, to the processor 310.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computer system 300.

The communications module 330 allows the computer system 300 to communicate with other computing devices and/or various communications networks such as, for example, the first network 120. For example, the communications module 330 may allow the computer system 300 to send or receive communications signals. Communications signals may be sent or received according to one or more protocols or according to one or more standards. The communications module 330 may allow the computer system 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the computer system 300 to communicate using near-field communication (NFC), via Wi-Fi™, using Bluetooth™ or via some combination of one or more networks or protocols. In some embodiments, all or a portion of the communications module 330 may be integrated into a component of the computer system 300. For example, the communications module 330 may be integrated into a communications chipset.

The I/O module 340 is an input/output module. The I/O module 340 allows the computer system 300 to receive input from and/or to provide input to components of the computer system 300 such as, for example, various input modules and output modules. For example, the I/O module 340 may, as shown, allow the computer system 300 to receive input from and/or provide output to a display, such as the display 202 (FIG. 2).

The storage module 350 allows data to be stored and retrieved. In some embodiments, the storage module 350 may be formed as a part of the memory 320 and/or may be used to access all or a portion of the memory 320. Additionally or alternatively, the storage module 350 may be used to store and retrieve data from persisted storage other than the persisted storage (if any) accessible via the memory 320. In some embodiments, the storage module 350 may be used to store and retrieve data in/from a database. A database may be stored in persisted storage. Additionally or alternatively, the storage module 350 may access data stored remotely such as, for example, as may be accessed using a local area network (LAN), wide area network (WAN), personal area network (PAN), and/or a storage area network (SAN). In some embodiments, the storage module 350 may access data stored remotely using the communications module 330. In some embodiments, the storage module 350 may be omitted and its function may be performed by the memory 320 and/or by the processor 310 in concert with the communications module 330 such as, for example, if data is stored remotely.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

FIG. 4 depicts a simplified organization of software components stored in the memory 320 of the computer system 300. As illustrated, these software components include an operating system 400 and an application software 410.

The operating system 400 is software. The operating system 400 allows the application software 410 to access the processor 310 (FIG. 3), the memory 320, the communications module 330, the I/O module 340, and the storage module 350 of the client computer system 100. The operating system 400 may be, for example, Google™ Android™, Apple™ iOS™, UNIX™, Linux™, Microsoft™ Windows™, Apple OSX™ or the like.

The application software 410 adapts the computer system 300, in combination with the operating system 400, to operate as a device for performing a specific function. For example, where the computer system 300 is the administrator device, the application software 410 adapts the computer system 300 to perform operations of the administrator device 150 described herein. By way of example, such operations may include configuring a trusted list containing contact credentials for a plurality of members of a group and sending the trusted list to the server computer system 110. Where the computer system 300 is an instance of the client computer system 100, the application software 410 adapts the computer system 300 to load a virtual gift card into a mobile wallet and/or engage with the server computer system during an account provisioning process.

Where the computer system 300 is the server computer system 110, the application software 410 adapts the computer system 300 to perform operations associated with the server computer system 110 described herein including, for example: i) receiving, using the communications module via a network, a communication from an administrator device, the communication defining a trusted list containing electronic contact credentials for a plurality of members of a group; ii) sending one or more electronic messages, using the communications module via the network, to one or more members of the group using the electronic contact credentials for each such member of the group; iii) after sending the electronic messages, receiving an account provisioning request, the account provisioning request associated with an electronic messaging address; iv) authenticating the account provisioning request as being associated with a member of the group by determining that the electronic messaging address corresponds to one of the electronic contact credentials in the trusted list; and v) in response to authenticating the account provisioning request as being associated with a member of the group, configuring a threshold for an account associated with the account provisioning request to allow a first threshold, the first threshold being a higher threshold than a second threshold which is in effect for an account that is not associated with one of the members of the group.

Where the computer system 300 is one of the gift card merchant computer server systems 130, the application software 410 adapts the computer system 300 to, for example, facilitate the loading or reloading of a virtual gift card on the client computer system 100.

Where the computer system 300 is a smartphone or tablet, the application software 410 may be or may be a part of a smartphone or tablet application or “app”. In a particular example in which the computer system 300 is the client computer system 100, the application software 410 may be or may include a mobile wallet application as mentioned above.

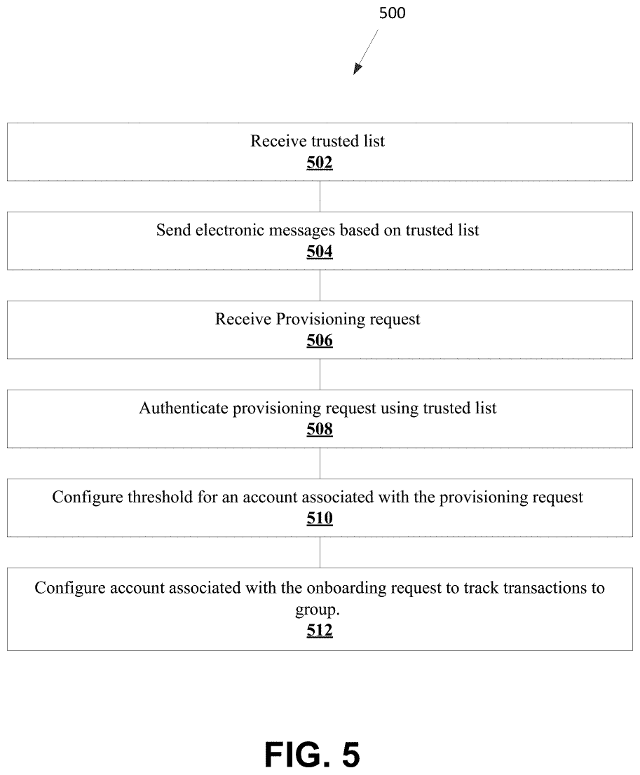

FIG. 5 provides a flowchart illustrating a method 500 for remotely provisioning a user account with a system. In performing the method 500, operations starting from an operation 502 and continuing onward are performed by a processor of the server computer system 110. For example, where the server computer system 110 is or includes an instance of the example computer server system 200, the operations may be performed by the processor 210 executing instructions such as, for example, from the memory 220. Those instructions may, for example, be part of a suitable instance of the application software 410 (FIG. 3).

In performing the method 500, a server computer system 110 may be in communication with an administrator device 150. Such communication may be by way of a network. The administrator device 150 may display a group management interface which may be used to create or modify a trusted list. A trusted list is a group of members that are to be associated with a group. The trusted list may define trusted entities. The group may be, for example, an organization such as a charitable organization, a fundraising organization, a sports team, a school, an employer, a union, etc. The trusted entities may be individuals that the administrator device 150 has verified as being associated with the group. For example, individuals may be employees of a company, members of a club or team or people affiliated with such members, members of a union, individuals associated with a school, etc.

In creating the trusted list, an administrator device 150 may receive, via an input interface associated with the administrator device 150, an electronic contact credential associated with each member of the group. The electronic contact credential may be, for example, an electronic messaging address such as an email address, SMS address (e.g., a telephone number), instant messaging address, or an electronic messaging address of another type.

The administrator device 160 may also receive, for each member of the group an identifier such as a name. The identifier may include one or more of a first name, a last name, a middle name, a middle initial or a nickname.

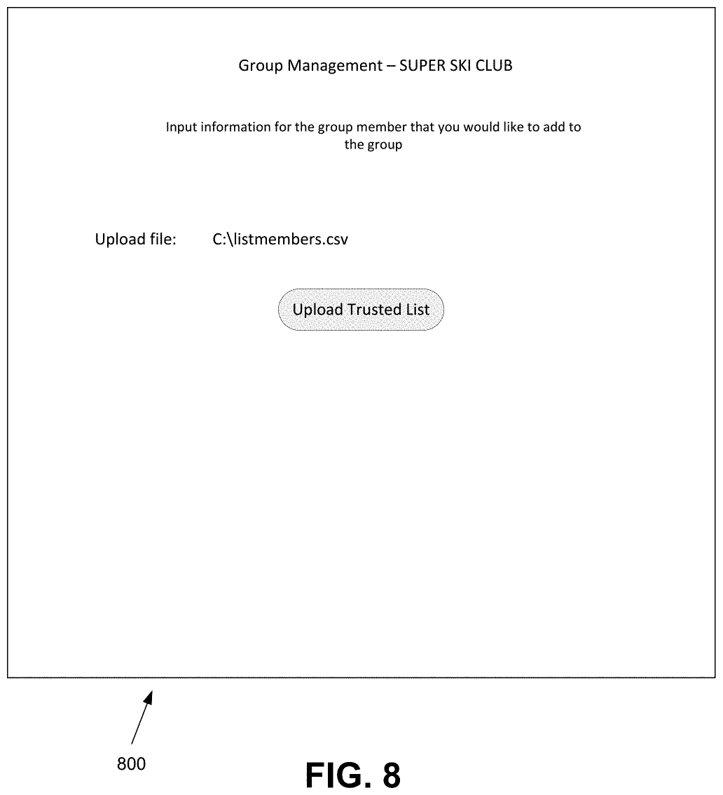

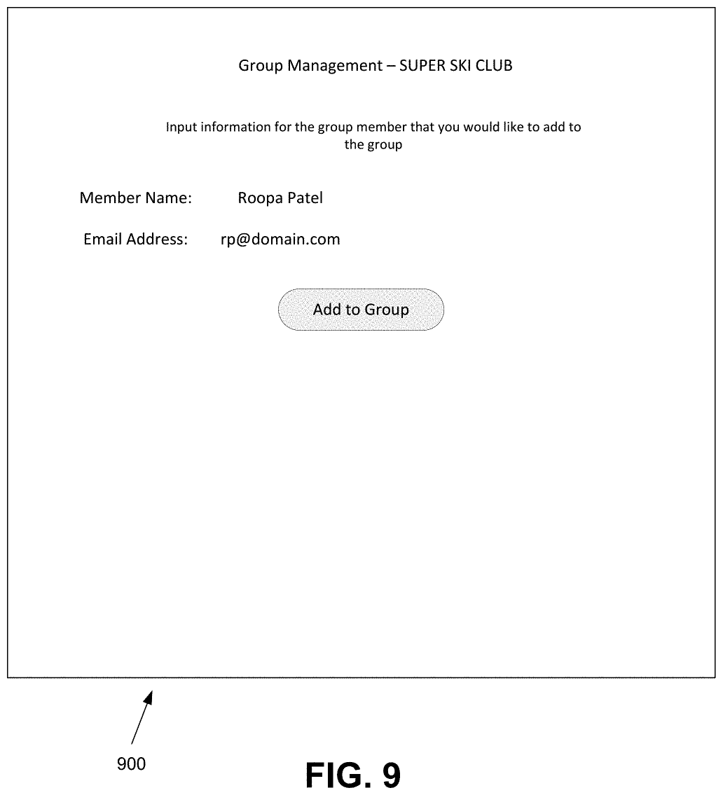

Example group management interfaces 800, 900 are illustrated in FIGS. 8 and 9 respectively. The example group management interface 800 of FIG. 8 may be used to configure a new group and the example group management interface 900 of FIG. 9 may be used to modify an existing group. In the example of FIG. 8, the group management interface includes interface elements for uploading a file that defines the trusted list. For example, the file may be a delimited data file such as a comma separated value (CSV) data file and/or may be a spreadsheet data file. In other implementations, the group management interface may include input fields for populating information about group members, such as a field for inputting electronic contact credentials and/or one or more fields for inputting other information associated with group members, such as name information.

The group management interfaces 800, 900 may, for example, be web interfaces that may be provided in a web browser operating on the administrator device 150. Web interfaces may be provided by a web server. The web server may be the server computer system 110 or may be associated with the server computer system 110.

Referring again to FIG. 5, at the operation 502, the server computer system 110 receives, using the communications module and via a network, a communication from an administrator device 150. The communication may define a trusted list containing electronic contact credentials for a plurality of members of a group. The communication may be or include an upload of a file containing the trusted list. For example, the file may be a delimited data file and/or a spreadsheet data file. In some implementations, the communication may be or include data input into one or more interface elements, such as input fields, of the group management interface.

At an operation 504, the server computer system 110 sends one or more electronic messages to one or more electronic devices associated with one or more members of the group (which may be client computer systems 100). Such messages may be sent using the communications module. Such messages may be sent via a network. The messages may be sent using the electronic contact credentials for each of the members of the group. For example, a first message may be sent to a first group member using a first electronic contact credential, which is associated with that first group member and a second message may be sent to a second group member using a second electronic contact credential, which is associated with that second group member.

The messages may be, for example, email messages, text messages, SMS messages, instant messages, or messages of another type.

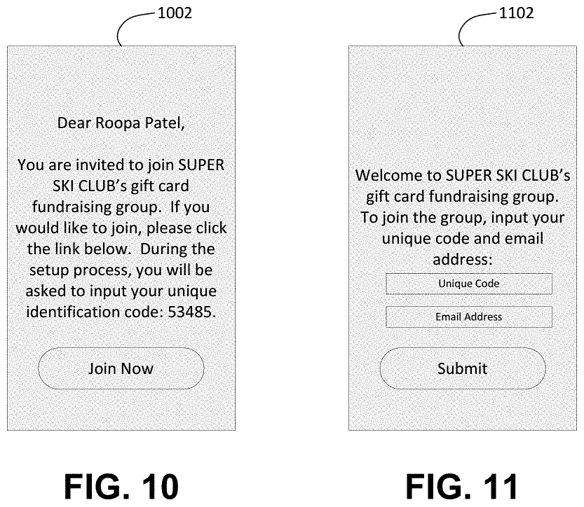

The messages may each include a selectable option to initiate account provisioning as a group member. “Account provisioning” may also be referred to as onboarding. For example, the selectable option may be an option to electronically join the group so as to be associated with the group in the server computer system 110. For example, the selectable option may be an option to submit an account provisioning request to the server computer system 110. An example of a possible message 1002 that may be sent is illustrated in FIG. 10. In the example, the selectable option to submit the account provisioning request is a button or link. The selectable option is, in the example, labelled “join now”. Other types of interface elements may be used in place of such a button.

The recipient of the message may interact with the selectable option in order to submit an account provisioning request. Accordingly, after the server computer system 110 sends the electronic messages it may, at operation 506, receive an account provisioning request. The account provisioning request may be associated with an electronic messaging address. That is, the account provisioning request may be received in such a way that the server computer system 110 is able to associate the request with a particular electronic messaging address. Various techniques may be used in order to allow the server computer system 110 to make such an association. For example, in some instances, upon activation of the selectable option to submit the account provisioning request, the device displaying the selectable option may then display a prompt 1102 (FIG. 11) for input of an electronic messaging address. After such input is received, it may be sent to the server computer system where it is received (e.g., at operation 506). In this way, the server computer system 110 is able to associate the account provisioning request with an electronic messaging address.

In another example, rather than prompt for input of the electronic messaging address, the electronic messaging address may be received in another way. For example, the selectable option included in the message may be a link which passes data to the server computer system 110. By way of example, the link may use a URL variable or another technique to pass data to the server computer system and the data that is passed may include the electronic contact credential to which the message was sent.

At an operation 508 the server computer system 110 authenticates the account provisioning request as being associated with a member of the group. Put differently, the server computer system 110 authenticates the account provisioning request as being associated with the group. The server computer system 110 may perform such authentication by determining that the electronic messaging address corresponds to one of the electronic contact credentials in the trusted list. By way of example, if the trusted list includes the email address rp@domain.com and the account provisioning request is associated with rp@domain.com, then the server computer system 110 may determine that the account provisioning request is, in fact, associated with the group.

In response to authenticating the account provisioning request as being associated with a member of the group, the server computer system 110 may onboard the user associated with the account provisioning request as a group member. For example, the server computer system 110 may configure an account for the user such that the account is associated with the group. For example, the server may configure the account such that the account automatically inherits one or more permissions or thresholds that have been defined for the group. For example, in response to authenticating the account provisioning request as being associated with a member of the group, the server computer system 110 may configure a threshold for an account associated with the account provisioning request to allow a first threshold to be used. The threshold may be a threshold that controls or limits the value of transactions that may be made in association with the server computer system 110. For example, the threshold may control or limit an amount of virtual gift cards that may be purchased by the user via the server computer system 110. For example, the threshold may control or limit the amount of virtual gift cards that may be loaded into a mobile wallet application on the user's device via the server computer system 110. The threshold may, for example, define a maximum transaction value over a defined period of time. The defined period of time may be, for example, a day, a week or a month. By way of example, the threshold may be a limit of $300 of virtual gift cards that may be purchased in any given day.

In some instances, the threshold may define a maximum transaction value for a single transaction. By way of example, the threshold may limit the amount of a single purchase of a virtual gift cards to $100.

Accordingly, the threshold may define a maximum amount of electronic gift cards that may be purchased by the account associated with the account provisioning request.

As noted above, the threshold is configured to the first amount (the first threshold) when the account provisioning request has been authenticated as being associated with a member of the group. Notably, this first threshold may be a higher threshold than a second threshold which is in effect for an account that is not associated with one of the members of the group. By way of example, the server may also allow non-group members to purchase virtual gift cards and to create accounts in order to do so. Such non-group members may follow a similar account provisioning process as group members but if they are determined to not be associated with a group, the non-group member account may be configured with a second threshold which is more restrictive than the first threshold. By way of example, if at operation 508 the server computer system 110 instead determined that the account provisioning request is not associated with the group—that is, that it was not sent by a group member—it may onboard the user as a non-group member. In doing so, the server computer system 110 may configure the user's account with the second threshold.

In summary, group member accounts may be configured with a first threshold that is a higher threshold than a second threshold which is in effect for an account that is not associated with one of the members of the group and not, therefore, associated with the group.

The server computer system 110 may take other actions instead of or in addition to configuring the threshold in response to authenticating the account provisioning request as being associated with a member of the group. For example, the server computer system 110 may configure the account associated with the account provisioning request such that transactions made with the account affect a ledger tracking total transactions made by all members of the group. That is, purchases of virtual gift cards using the account that is associated with the group may be tracked to a ledger of total purchases made by members of that group. Such transactions may be used, for example, to allow for group rewards. For example, a percentage of the total amount of transactions associated with a group (e.g. total value of virtual gift cards purchased) may be transferred to an account associated with the group. In contrast, purchases made by non-group members do not affect the ledger of total purchases made by members of that group.

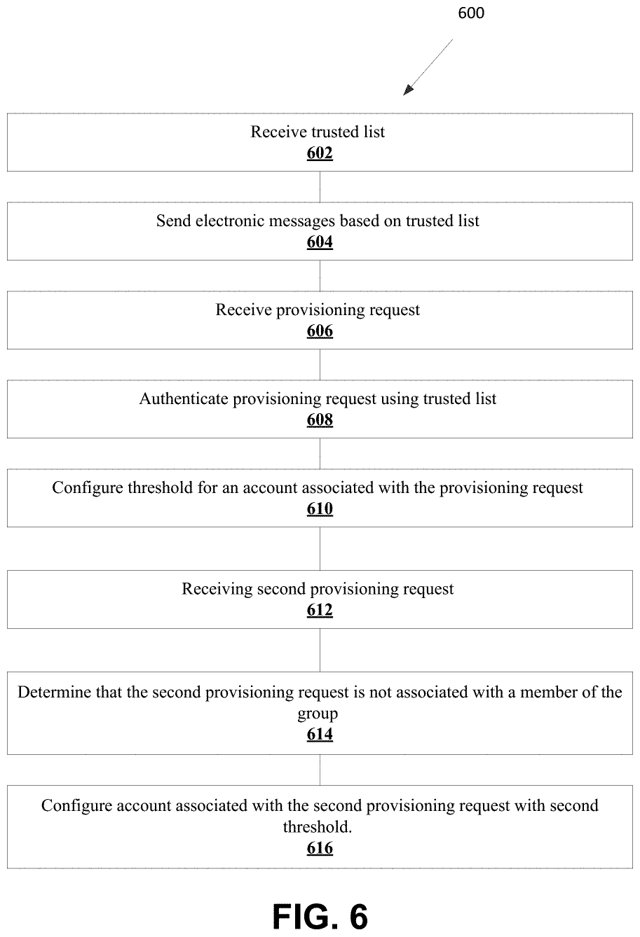

FIG. 6 provides a flowchart illustrating a further method 600 for remotely provisioning a user account with a system. FIG. 6 illustrates how the server computer system 110 differently handles account provisioning requests from group members and account provisioning requests from non-group members. In performing the method 600, operations starting from an operation 602 and continuing onward are performed by a processor of the server computer system 110. For example, where the server computer system 110 is or includes an instance of the example computer server system 200, the operations may be performed by the processor 210 executing instructions such as, for example, from the memory 220. Those instructions may, for example, be part of a suitable instance of the application software 410 (FIG. 3).

Many of the operations of the method 600 are similar to those of the method 500 and, for the sake of brevity for the reader, the discussion of such operations will not be repeated at length.

At operation 602, the server computer system 110 may receive a trusted list. Operation 602 may be performed in the same or a similar manner to operation 502 of the method 500 of FIG. 5.

At operation 604, the server computer system 110 may send electronic messages based on the trusted list. Operation 604 may be performed in the same or a similar manner to operation 504 of the method 500 of FIG. 5.

At operation 606, the server computer system 110 receive an account provisioning request. Operation 606 may be performed in the same or a similar manner to operation 506 of the method 500 of FIG. 5.

At operation 608, the server computer system 110 may authenticate the account provisioning request using the trusted list. Operation 608 may be performed in the same or a similar manner to operation 508 of the method 500 of FIG. 5.

In response to authenticating the account provisioning request as being associated with the group, at operation 610, the server computer system 110 may configure a threshold for an account associated with the account provisioning request to be associated with the first (higher and/or less restrictive) threshold. Operation 610 may be performed in the same or a similar manner to operation 510 of the method 500 of FIG. 5.

While not illustrated in FIG. 6, an operation that is the same or similar to operation 512 of the method 500 of FIG. 5 may be performed in response to authenticating the account provisioning request as being associated with the group.

At operation 612, the server computer system 110 receives a second account provisioning request. The second account provisioning request may be received using the communications module. The second account provisioning request may be received via the network. The second account provisioning request may be received from a device that is different from the device from which the account provisioning request was received at operation 606. For example, a user of another device who is not a group member and did not receive one of the electronic messages sent at operation 604 may send the second account provisioning request. The second account provisioning request is associated with a second electronic messaging address. The second electronic messaging address may be an electronic messaging address that was input by a user.

At operation 614, the server computer system 110 determines that the second account provisioning request is not associated with a member of the group. Put differently, the server computer system 110 determines that the second account provisioning request is not associated with the group. This may include determining that the second electronic messaging address does not correspond to one of the electronic contact credentials in the trusted list.

In response to determining that the second account provisioning request is not associated with a member of the group, at an operation 616, the server computer system 110 configures an account associated with the second account provisioning request with the second threshold. The second threshold is lower than the first threshold such that the account associated with the second account provisioning request has greater limitations than the account associated with the account provisioning request received at operation 606. For example, the second threshold may prevent purchase of an amount of virtual gift cards that would not be prevented by the first threshold.

It may be noted that, when the server computer system 110 determines that the second account provisioning request is not associated with a member of the group, the account associated with the second account provisioning request is not configured to track transactions to the group (e.g., operation 612 is not performed for the account associated with the second account provisioning request).

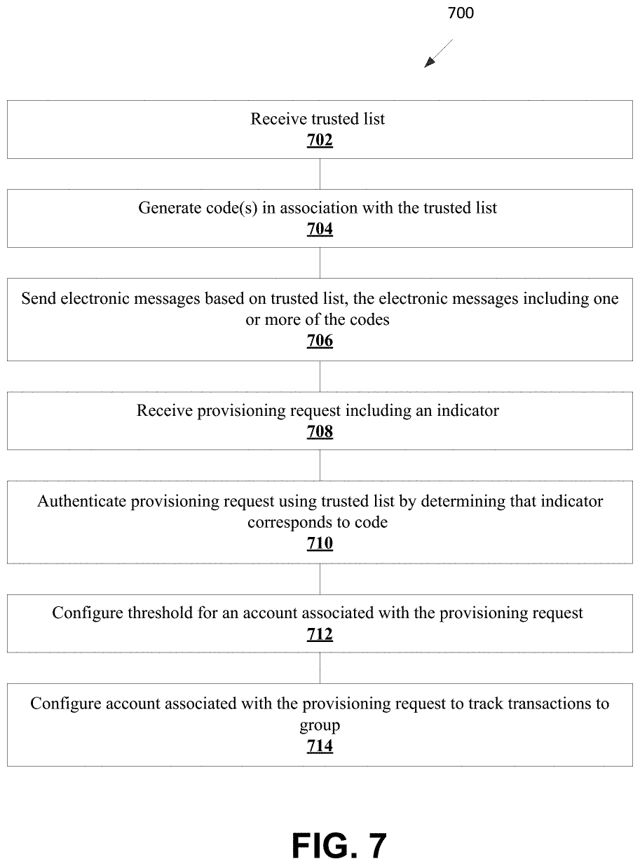

Reference will now be made to FIG. 7. FIG. 7 provides a flowchart illustrating a further method 700 for remotely provisioning a user account with a system. FIG. 7 illustrates how additional authentication measures may be employed by the server computer system 110. In performing the method 700, operations starting from an operation 702 and continuing onward are performed by a processor of the server computer system 110. For example, where the server computer system 110 is or includes an instance of the example computer server system 200, the operations may be performed by the processor 210 executing instructions such as, for example, from the memory 220. Those instructions may, for example, be part of a suitable instance of the application software 410 (FIG. 3).

Many of the operations of the method 700 are similar to those of the method 500 and, for the sake of brevity for the reader, the discussion of such operations will not be repeated at length.

At operation 702, the server computer system 110 may receive a trusted list. Operation 702 may be performed in the same or a similar manner to operation 502 of the method 500 of FIG. 5.

At operation 704, the server computer system 110 may generate one or more codes in association with the trusted list. The codes may be, for example, generated using a random or pseudo random number generator. In other implementations, the codes may be generated in a deterministic manner. In some instances, codes may be generated sequentially or by performing an operation on a last-generated code.

The codes may, in some implementations, be or include a group code. That is, a single group code may be generated for a group. In other implementations, the codes may be or include individual codes. For example, the codes may be unique for each individual user. The codes may be added to or otherwise associated with the trusted list. For example, the trusted list may be updated in storage associated with the server computer system such that the trusted list is, as a whole, associated with a group code or such that individual members identified in the trusted list are each associated with a code such as an individual code.

At operation 706, the server computer system 110 may send electronic messages based on the trusted list. Operation 706 may be performed in the same or a similar manner to operation 504 of the method 500 of FIG. 5. However, in the operation 706, the electronic messages may each include at least one of the codes. Referring, for example, to FIG. 10, an example message 902 includes a unique identification code. The message may include a selectable option which, when activated, causes a prompt 1102 (FIG. 11) for input of the unique code to be displayed.

At operation 708, the server computer system 110 may receive an account provisioning request. Operation 708 may be performed in the same or a similar manner to operation 506 of the method 500 of FIG. 5. However, the account provisioning request at operation 708 includes or is otherwise associated with an indicator. The indicator may represent user input and may, for example, represent a response to the prompt 1102 for the unique code. That is, the indicator may be the contents of an input field which is intended for receiving input of the unique code.

At operation 710, the server computer system 110 may authenticate the account provisioning request using the trusted list. Operation 710 may be performed in the same or a similar manner to operation 508 of the method 500 of FIG. 5. However, at operation 710, the server computer system 110 may also verify that the indicator corresponds to one of the one or more codes. That is, the server computer system 110 may verify that the indicator represents a code that is associated with the group and/or the individual that is associated, in the trusted list, with an electronic messaging address identified by or associated with the account provisioning request.

In response to authenticating the account provisioning request as being associated with the group, at operation 712, the server computer system 110 configures a threshold for an account associated with the account provisioning request to be associated with the first (higher and/or less restrictive) threshold. Operation 712 may be performed in the same or a similar manner to operation 510 of the method 500 of FIG. 5. As with the methods 500 and 600 of FIGS. 5 and 6, if the account provisioning request was not associated with a group member then the threshold would be configured to a lesser threshold.

In response to authenticating the account provisioning request as being associated with the group, at operation 714, the server computer system 110 configures a threshold for an account associated with the account provisioning request to be associated with the first (higher and/or less restrictive) threshold. Operation 714 may be performed in the same or a similar manner to operation 512 of the method 500 of FIG. 5.

After an account has been initialized using one of the methods 500, 600, 700 or a variation thereof, the account may be used to, for example, configure a transfer of value between database records. For example, the account may be used to purchase a virtual gift card such that the virtual gift card may be used on a device associated with the account. By way of example, a virtual gift card may be loaded into a wallet associated with a mobile device.

After an account has been initialized, the permissions and/or thresholds associated with the account control whether certain purchases of virtual gift cards will be permitted. Put differently, after the account has been initialized, the permissions and/or thresholds control the transfer of value between database records. The purchase of a virtual gift card involves value being transferred to records. For example, the purchase of a virtual gift card may involve a ledger defining a balance associated with a virtual gift card to increased. By way of example, if a $100 virtual gift card is purchased, a ledger defining the balance for the gift card may be increased by $100. In exchange for the gift card, the party purchasing the gift card transfers value, such as fiat currency, blockchain tokens, etc., from another source. For example, the party purchasing the gift card may pay with a payment card such as a credit card and so a balance associated with the payment card may be adjusted as part of the transfer. That is, a database record associated with the payment card may be debited by the value of the virtual gift card (e.g., $100 in the example). A payment processor may then transfer an amount corresponding to the debited amount (less any service fees) to a merchant associated with the virtual gift card. That is, a database record associated with the merchant may be credited based on the value of the virtual gift card. Thus, it may be seen that the thresholds operate to control the transfer of value between database records; higher thresholds allow for greater and, in at least some instances, more frequent purchases of virtual gift cards. Since thresholds may operate to limit the frequency of purchases, the thresholds may operate to control the use of resources associated with the server computer system 110 since more frequent purchases will use more system resources than less frequent purchases. Resources may, therefore, be controlled by simply limiting the number of groups in the system.

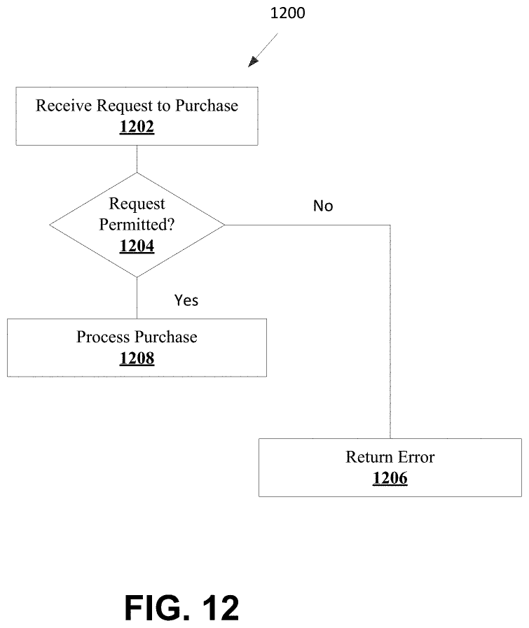

Reference will now be made to FIG. 12. FIG. 12 provides a flowchart illustrating a further method 1200 for remotely provisioning a user account with a system. In performing the method 1200, operations starting from an operation 1202 and continuing onward are performed by a processor of the server computer system 110. For example, where the server computer system 110 is or includes an instance of the example computer system 200, the operations may be performed by the processor 210 executing instructions such as, for example, from the memory 220. Those instructions may, for example, be part of a suitable instance of the application software 410 (FIG. 3).

At operation 1202, the server computer system receives a request to purchase a virtual gift card. The request may be received in association with an account. The request may be received from a remote device associated with a user who may or may not be a member of a group.

The request may define a desired purchase amount. At operation 1204, the server computer system determines, based on the desired purchase amount and the threshold, whether the purchase is permitted. If it is not permitted, at operation 1206, the server computer system 110 may return an error message indicating that the defined purchase amount is over the threshold. The error message may indicate the amount of the threshold.

If, instead, the server computer system 110 determines, based on the desired purchase amount and the threshold, that the purchase is permitted, it may process the purchase. For example, the server computer system 110 may communicate with a gift card merchant API 132 to effect the purchase and load the virtual gift card into a mobile wallet on the user's device.

While FIG. 12 illustrates how requests may be approved or denied based on the defined permissions/thresholds, in other instances, the permissions/thresholds may instead be implemented through modification of a user interface that is used to purchase virtual gift cards. For example, prior to displaying the virtual gift card purchase user interface on a remote device, a threshold/permission associated with an account may be determined and used to modify the user interface. For example, if the threshold is a higher first threshold, then an option to purchase an amount of virtual gift cards up to the first threshold amount may be provided but, if the threshold is a lower second threshold, then the option to purchase an amount of virtual gift cards up to the first amount is not provided. Instead, an option to purchase an amount of virtual gift cards up to the second amount may be provided.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A computer system comprising:
a processor;
a communications module coupled to the processor; and
a memory coupled to the processor and storing instructions that, when executed by the processor, cause the computer system to:
receive, using the communications module via a network, a communication from an administrator device, the communication defining a trusted list containing electronic contact credentials for a plurality of members of a group;
send one or more electronic messages, using the communications module via the network, to one or more electronic devices associated with members of the group using the electronic contact credentials for each such member of the group;
after sending the electronic messages, receive an account provisioning request, the account provisioning request associated with an electronic messaging address;
authenticate the account provisioning request as being associated with a member of the group by determining that the electronic messaging address corresponds to one of the electronic contact credentials in the trusted list; and
in response to authenticating the account provisioning request as being associated with a member of the group, configure a threshold for an account associated with the account provisioning request to allow a first threshold, the first threshold being a higher threshold than a second threshold which is in effect for an account that is not associated with one of the members of the group.

2. The computer system of claim 1, wherein the instructions further cause the computer system to:
in response to authenticating the account provisioning request as being associated with a member of the group, configure the account associated with the account provisioning request such that transactions made with the account affect a ledger tracking total transactions made by all members of the group.

3. The computer system of claim 1, wherein the threshold defines a maximum transaction value over a defined time period.

4. The computer system of claim 3, wherein the defined time period is one or more of a day, a week or a month.

5. The computer system of claim 1, wherein the threshold defines a maximum transaction value for a single transaction.

6. The computer system of claim 1, wherein the threshold defines a maximum amount of electronic gift cards that may be purchased by the account associated with the account provisioning request.

7. The computing system of claim 1, wherein the instructions further cause the computer system to:
receive a second account provisioning request, the second account provisioning request associated with a second electronic messaging address;
determine that the second account provisioning request is not associated with a member of the group by determining that the second electronic messaging address does not correspond to one of the electronic contact credentials in the trusted list; and
in response to determining that the second account provisioning request is not associated with the member of the group, configure an account associated with the second account provisioning request with the second threshold.

8. The computer system of claim 1, wherein the instructions further cause the computer system to:
generate one or more codes in association with the trusted list and wherein the one or more electronic messages each include at least one of the codes,
and wherein the account provisioning request includes an indicator and wherein authenticating the account provisioning request as being associated with a member of the group includes determining that the indicator corresponds to one of the one or more codes.

9. The computer system of claim 8, wherein the indicator represents user input.

10. The computer system of claim 8, wherein generating one or more codes includes generating a single group code for the group.

11. A computer-implemented method comprising:
receiving, via a network, a communication from an administrator device, the communication defining a trusted list containing electronic contact credentials for a plurality of members of a group;
sending one or more electronic messages via the network to one or more electronic devices associated with members of the group using the electronic contact credentials for each such member of the group;
after sending the electronic messages, receiving an account provisioning request, the account provisioning request associated with an electronic messaging address;
authenticating the account provisioning request as being associated with a member of the group by determining that the electronic messaging address corresponds to one of the electronic contact credentials in the trusted list; and
in response to authenticating the account provisioning request as being associated with a member of the group, configuring a threshold for an account associated with the account provisioning request to allow a first threshold, the first threshold being a higher threshold than a second threshold which is in effect for an account that is not associated with one of the members of the group.

12. The method of claim 11, further comprising:
in response to authenticating the account provisioning request as being associated with a member of the group, configuring the account associated with the account provisioning request such that transactions made with the account affect a ledger tracking total transactions made by all members of the group.

13. The method of claim 11, wherein the threshold defines a maximum transaction value over a defined time period.

14. The method of claim 13, wherein the defined time period is one or more of a day, a week or a month.

15. The method of claim 11, wherein the threshold defined a maximum transaction value for a single transaction.

16. The method of claim 11, wherein the threshold defines a maximum amount of electronic gift cards that may be purchased by the account associated with the account provisioning request.

17. The method of claim 11, further comprising:
receiving a second account provisioning request, the second account provisioning request associated with a second electronic messaging address;
determining that the second account provisioning request is not associated with a member of the group by determining that the second electronic messaging address does not correspond to one of the electronic contact credentials in the trusted list; and
in response to determining that the second account provisioning request is not associated with the member of the group, configuring an account associated with the second account provisioning request with the second threshold.

18. The method of claim 11, further comprising:
generating one or more codes in association with the trusted list and wherein the one or more electronic messages each include at least one of the codes,
and wherein the account provisioning request includes an indicator and wherein authenticating the account provisioning request as being associated with a member of the group includes determining that the indicator corresponds to one of the one or more codes.

19. The method of claim 18, wherein the indicator represents user input.

20. The method of claim 18, wherein generating one or more codes includes generating a single group code for the group.
